(19) United States
(12) Patent Application Publication
(10) Pub. No.: US 2022/0065977 A1
(43) Pub. Date: Mar. 3, 2022

(54) CITY-SCALE ACOUSTIC IMPULSE DETECTION AND LOCALIZATION

(71) Applicant: NEC Laboratories America, Inc., Princeton, NJ (US)

(72) Inventors: Sarper OZHARAR, Princeton, NJ (US); Yue TIAN, Princeton, NJ (US); Shaobo HAN, Plainsboro, NJ (US); Ting WANG, West Windsor, NJ (US); Yangmin DING, North Brunswick, NJ (US)

(73) Assignee: NEC LABORATORIES AMERICA, INC, Princeton, NJ (US)

(21) Appl. No.: 17/409,792

(22) Filed: Aug. 24, 2021

Related U.S. Application Data
(60) Provisional application No. 63/069,791, filed on Aug. 25, 2020.
(60) Provisional application No. 63/140,977, filed on Jan. 25, 2021.

(51) Int. Cl. G01S 3/808; G01H 9/00

(52) U.S. Cl. CPC G01S 3/8083; G01H 9/004

(57) ABSTRACT

Aspects of the present disclosure describe distributed fiber optic sensing (DFOS) systems, methods, and structures that advantageously enable city-scale acoustic impulse detection and localization using standard, live aerial telecommunications optical fiber cables through the use of distributed acoustic sensing exhibiting an error of less than 1.22 m.

### CROSS REFERENCE

This disclosure claims the benefit of U.S. Provisional Patent Application Ser. No. 63/069,791 filed 25 Aug. 2020 and U.S. Provisional Patent Application Ser. No. 63/140,977 filed 25 Jan. 2021, the entire contents of each is incorporated by reference as if set forth at length herein.

### TECHNICAL FIELD

This disclosure relates generally to distributed fiber optic sensing (DFOS) systems, methods, and structures. More specifically, it pertains to the detection and localization of acoustic events across a city-scale environment using DFOS.

### BACKGROUND

Distributed fiber optic sensing (DFOS) systems, methods, and structures have shown great utility in a number of unique sensing applications due to their intrinsic advantages over conventional technologies. They can be integrated into normally inaccessible areas and can function in very harsh environments. They are immune to radio frequency interference and electromagnetic interference and can provide continuous, real-time measurements along entire lengths of fiber optic cable(s).

Recent advances in DFOS technologies have been shown to allow for continuous, long-distance sensing over existing telecommunications networks, enabling telecommunications carriers to provide not only communications services but also a variety of sensing services including, but not limited to, traffic/road condition monitoring, infrastructure monitoring, and intrusion detection, using the same network. When used in this manner, an entire telecommunications network may now act as a large-scale sensor enabling—for example—constant monitoring of an environment including one spanning an entire city or other large community.

### SUMMARY

Advance in the art is made according to aspects of the present disclosure directed to distributed fiber optic sensor (DFOS) systems, methods, and structures that monitor an entire community including a city or other urban environment(s) using acoustic DFOS techniques. At the heart of our disclosure, is our inventive method that analyzes acoustic events and localizes their source(s).

In sharp contrast to the prior art, systems, methods, and structures according to aspects of the present disclosure effectively transform fiber optic cables—that may already be deployed in an environment such as telecommunications cables—into a “microphone array” that advantageously permits detecting and locating acoustic events while discriminating acoustic events of interest from normal, everyday acoustic events that occur in such a setting.

Of particular advantage—and in further contrast to the prior art—systems, methods, and structures according to aspects of the present disclosure only require a DFOS distributed acoustic sensing (DAS) system that may be conveniently centrally located, a fiber optic cable—preferably one(s) already deployed—that is/are used as a microphone array, and our inventive method that as we have noted analyzes acoustic events and localizes their source(s).

As we shall show and describe, particular distinguishing aspects of systems, methods and structures according to the present disclosure include—but are not limited to—use existing deployed fiber optic cable thereby eliminating any additional deployment cost(s); providing a city-wide/community-wide surveillance area that is scalable to larger area(s) by adding more fiber route(s); and exhibiting an ability to adaptively “move” or change (add/delete) listening points (i.e., fiber “microphones”) without physically/mechanically moving anything. Our inventive methods and systems are evaluated and demonstrate distributed acoustic detection and localization of acoustic events using standard, live aerial telecommunications optical fiber cables while exhibiting an error of less than 1.22 m.

### BRIEF DESCRIPTION OF THE DRAWING

A more complete understanding of the present disclosure may be realized by reference to the accompanying drawing in which:

FIG. 1 is a schematic diagram of an illustrative distributed fiber optic sensing system and operation generally known in the art;

FIG. 2 is a flow chart illustrating the operation of DFOS according to aspects of the present disclosure;

FIG. 3 is a schematic diagram showing an illustrative physical layout of an acoustic event detection according to aspects of the present disclosure;

FIG. 4 is a plot of a waterfall graph showing both time and spatial characteristics of an acoustic event according to aspects of the present disclosure;

FIG. 5 is series of plots showing time domain signals received at selected virtual microphones according to aspects of the present disclosure;

FIG. 6 is series of plots showing running variance of selected virtual microphones as a function of sample number according to aspects of the present disclosure;

FIG. 7 is series of plots showing running 1/p values of the virtual microphones according to aspects of the present disclosure;

FIG. 8 is a plot showing a calculated most probable acoustic event (gunshot) location shown on a 2D map according to aspects of the present disclosure;

FIG. 9 is a plot showing a heat-map-like demonstration of possible acoustic event location (gunshot) shown on a 2D map according to aspects of the present disclosure;

FIG. 10 is a birds-eye view plan of our illustrative test bed according to aspects of the present disclosure;

FIG. 11 is a plot showing an illustrative waterfall image of an acoustic event detected by DAS in which each ellipse corresponds to a different sensor point for our illustrative experimental testing according to aspects of the present disclosure;

FIG. 12 is a plot showing detected acoustic event by four reference points a) spool, b) pole, c) pole 2 and d) pole 3 for our experimental testing according to aspects of the present disclosure; and

FIG. 13 is a plot showing illustrative source locations together with actual source locations on test bed map for our experimental testing according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

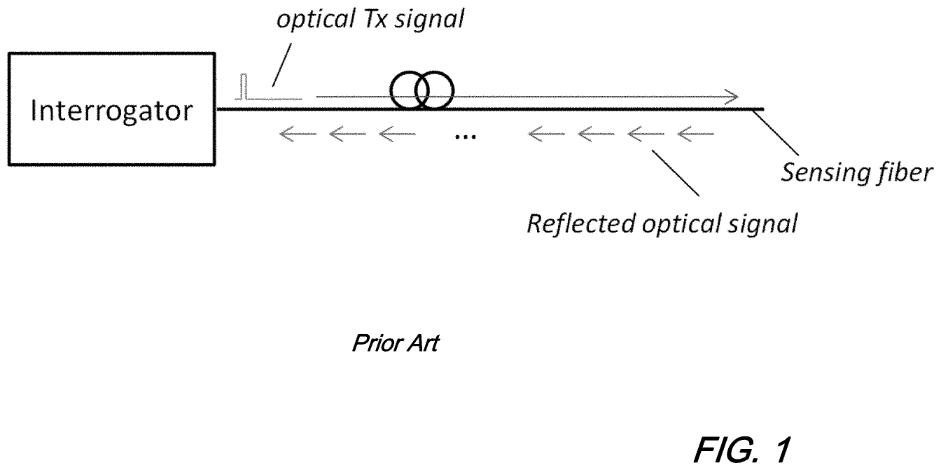

By way of some additional background—and with reference to FIG. 1 which is a schematic diagram of an illustrative distributed fiber optic sensing system generally known in the art—we begin by noting that distributed fiber optic sensing (DFOS) is an important and widely used technology to detect environmental conditions (such as temperature, vibration, stretch level etc.) anywhere along an optical fiber cable that in turn is connected to an interrogator. As is known, contemporary interrogators are systems that generate an input signal to the fiber and detects/analyzes the reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. It can also be a signal of forward direction that uses the speed difference of multiple modes. Without losing generality, the following description assumes reflected signal though the same approaches can be applied to forwarded signal as well.

As will be appreciated, a contemporary DFOS system includes an interrogator that periodically generates optical pulses (or any coded signal) and injects them into an optical fiber. The injected optical pulse signal is conveyed along the optical fiber.

At locations along the length of the fiber, a small portion of signal is reflected and conveyed back to the interrogator. The reflected signal carries information the interrogator uses to detect, such as a power level change that indicates—for example—a mechanical vibration.

The reflected signal is converted to electrical domain and processed inside the interrogator. Based on the pulse injection time and the time signal is detected, the interrogator determines at which location along the fiber the signal is coming from, thus able to sense the activity of each location along the fiber.

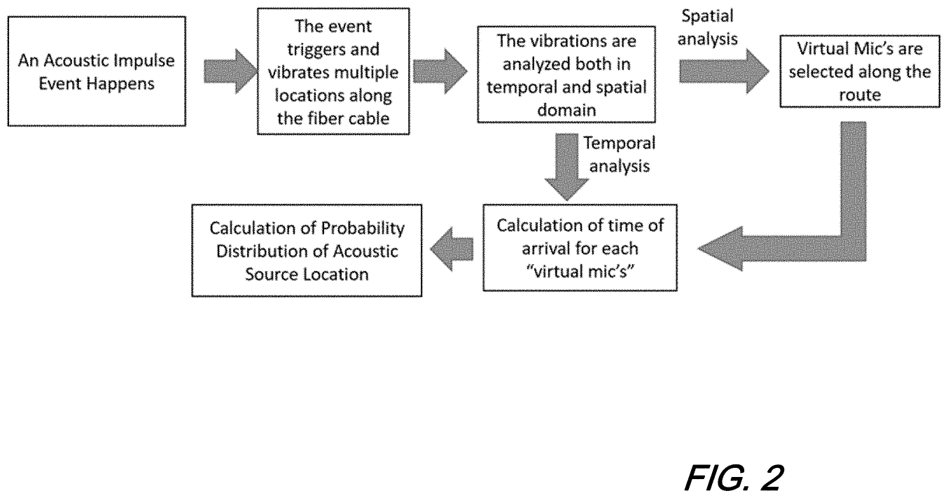

FIG. 2 is a flow chart illustrating the overall operation of DFOS according to aspects of the present disclosure. With reference to that figure, it may be understood that operation of our inventive system and method begins with an acoustic event happening within a surveillance area—i.e., that geographical area in which a sensing fiber is operational. As previously noted and according to aspects of the present disclosure, such sensing fiber may be deployed as part of our sensing system—or may be previously deployed and operating to convey telecommunications or other data traffic.

Generally, such an acoustic event produces an acoustic vibration in the air which is then detected by the fiber optic cable. Such vibrations may advantageously be detected by a DAS system—including interrogator and analysis system and/or AI—based system—which is/are located in a central office—or other location including cloud systems—away from the actual acoustic event. As noted previously and will be described in greater detail—detected signals resulting from the acoustic event(s) are analyzed using our inventive method(s) including both spatial domain, and temporal domain analysis.

As those skilled in the art will understand and appreciate, a spatial domain analysis—according to aspects of the present disclosure—determines which point(s) along a sensing fiber optic have detected an acoustic disturbance/signal, and those points are selected as our virtual microphones. In a next step, our inventive method determines a time of arrival of the signal(s) for each virtual microphone. Once a time signature is determined for each virtual microphone, the location(s) (i.e. the coordinates) of this acoustic event is determined as a probability distribution on an actual map, based on the physical location(s) of the virtual microphones.

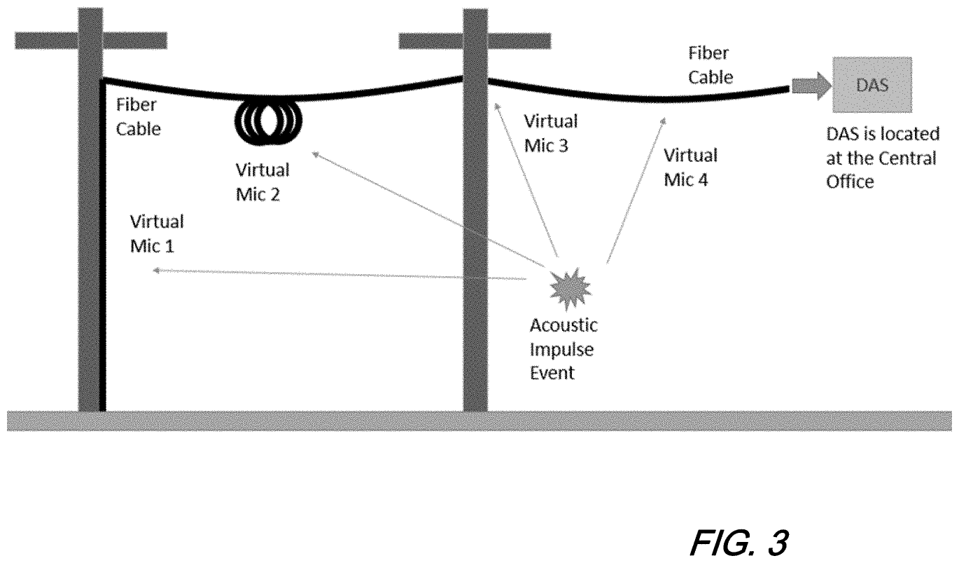

FIG. 3 is a schematic diagram showing an illustrative physical layout of an acoustic event detection according to aspects of the present disclosure. As may be observed from that figure, several utility poles are shown suspending a length of fiber optic (sensing) cable that is further optically connected to a distributed acoustic sensing (DAS) system that may be conveniently located in a central office or other convenient location.

Operationally, when an acoustic event occurs in an environment in which the sensing fiber optic cable occurs—for example in an urban environment in an unknown location—acoustic vibrations due to this event create a traveling vibration pattern in three dimensions (3D) which subsequently interact with the fiber optic cable generating strain changes at multiple locations of the fiber optic cable at different times. These strain(s) (vibration patterns) are detected both time and space domains by the DAS system at the central office and analyzed.

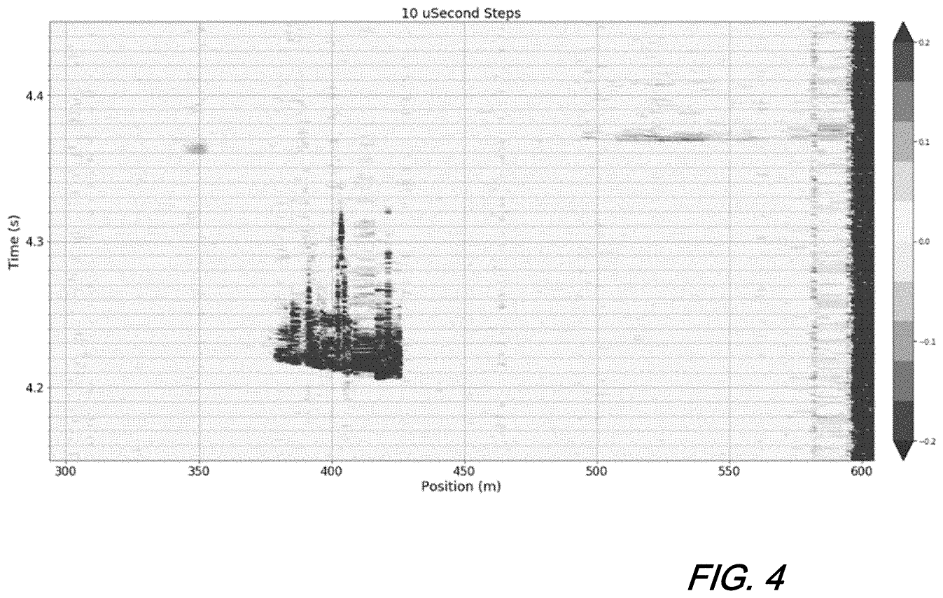

FIG. 4 is a plot of a waterfall graph showing both time and spatial characteristics of an acoustic event according to aspects of the present disclosure. From this plot, those skilled in the art will know that the time and position of the strain(s) induced by vibration patterns may be determined.

Operationally, and according to aspects of the present disclosure, a set of “virtual microphones” are selected. The virtual microphones” selected are generally those locations along the fiber optic cable route exhibiting the most sensitivity to strain and hence, acoustic events. Such understood locations include—for example—a down-lead fiber optic cable along a pole, a spool of fiber optic cable, fiber optic connection points to a pole, or a central part (substantially midpoint) of a fiber optic cable length.

Once the virtual microphones are selected, signal(s) recorded by each of these microphones is/are analyzed using a change point detection algorithm such as a Z-test, and the time of arrival is calculated for each microphone.

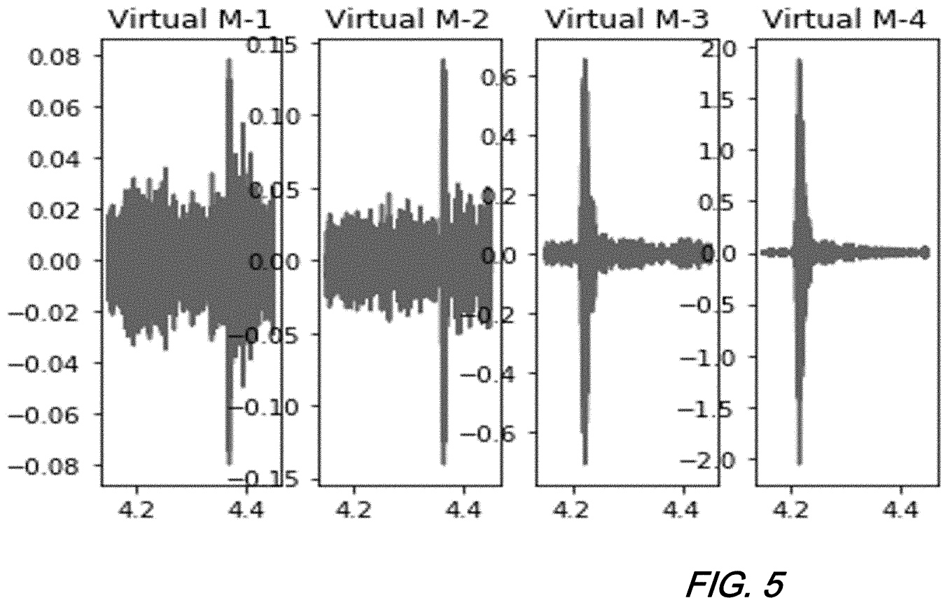

FIG. 5 is series of plots showing time domain signals received at selected virtual microphones according to aspects of the present disclosure. As is shown in those plots, each of the individual virtual microphones (Virtual M-1, Virtual M-2, Virtual M-3, and Virtual M-4) each indicate different detected strain (acoustic) characteristics experienced at each of the individual virtual microphone locations along the sensor fiber optic cable.

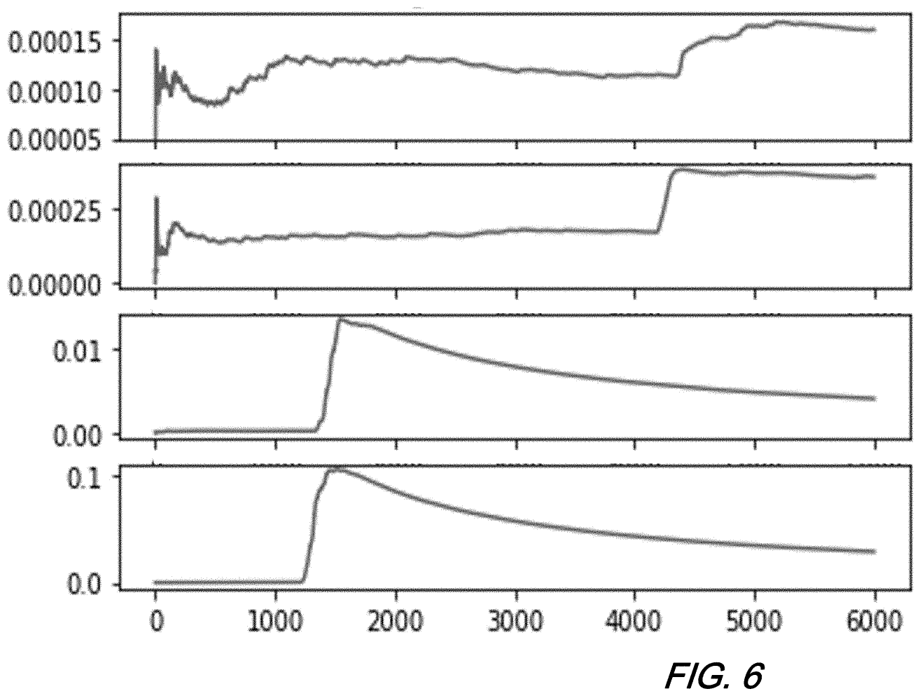

FIG. 6 is series of plots showing running variance of selected virtual microphones as a function of sample number according to aspects of the present disclosure. As may be observed and as shown in this series of plots in the figure, the differences in running variance for each of the virtual microphones of FIG. 5.

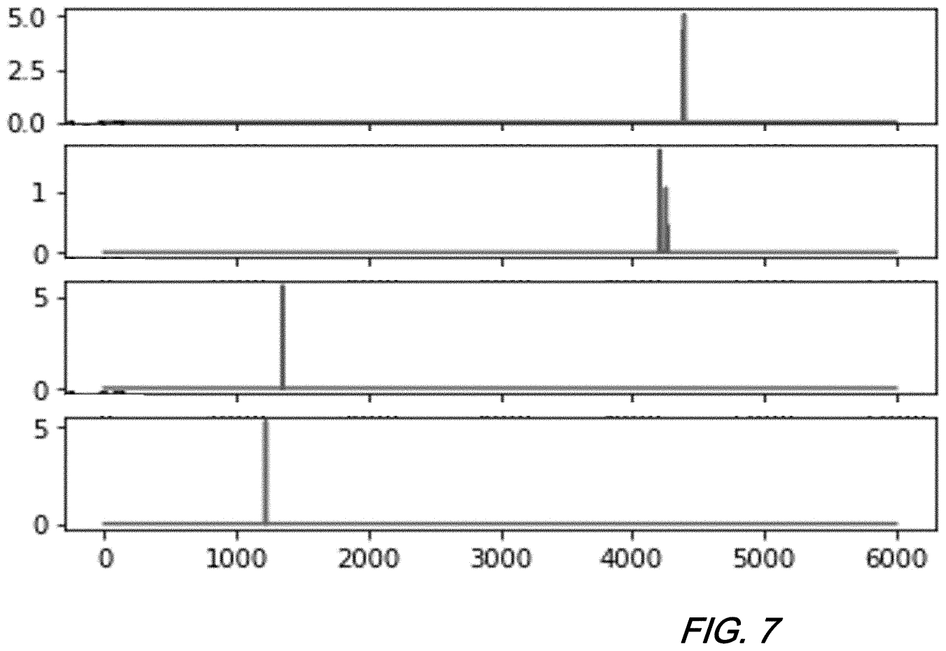

Finally, FIG. 7 is series of plots showing running 1/p values of the virtual microphones of FIG. 5 and FIG. 6 according to aspects of the present disclosure. As may be observed from this figure, a “change point” may be selected for each virtual microphone.

Next, a time difference matrix, involving a relative time difference between all virtual microphone combinations, is generated, an example of which is shown in the table below.

Exemplary Relative Time Difference Matrix

| | 0 | 1 | 2 | 3 |
|---|---|---|---|---|
| 0 | 0.000 | 2.2638 | 52.1703 | 54.2969 |
| 1 | −2.2638 | 0.0000 | 49.9065 | 52.0331 |
| 2 | −52.1703 | −49.9065 | 0.0000 | 2.1266 |
| 3 | −54.2969 | −52.0331 | −2.1266 | 0.0000 |

We note that the time difference matrix together with the geometric physical positions of the virtual microphones are then used in a 3-dimensional acoustic-location-error function, whose minimum value determination provides a most probable location of the acoustic event(s).

Advantageously, this determination may be output in at least two convenient and informative formats. First, a single location for the acoustic event source can be displayed on a 2-dimensional map. Second, and perhaps more informative, system noise and imperfections may be considered to further improve the results and a heat-map-like distribution map can be generated for the source location. When so displayed, a greater probability location may be readily determined from the map.

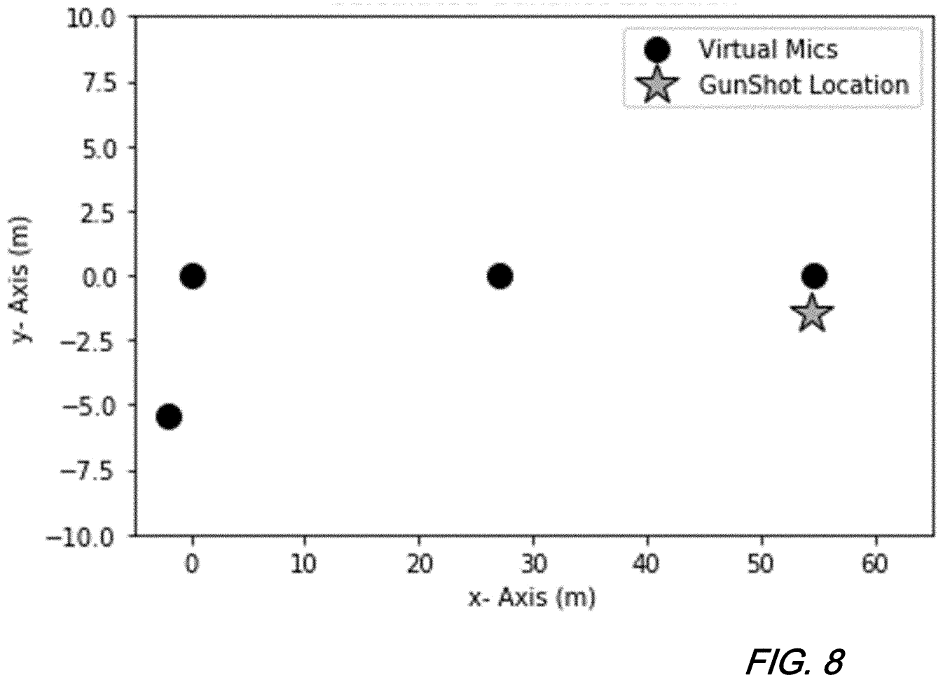

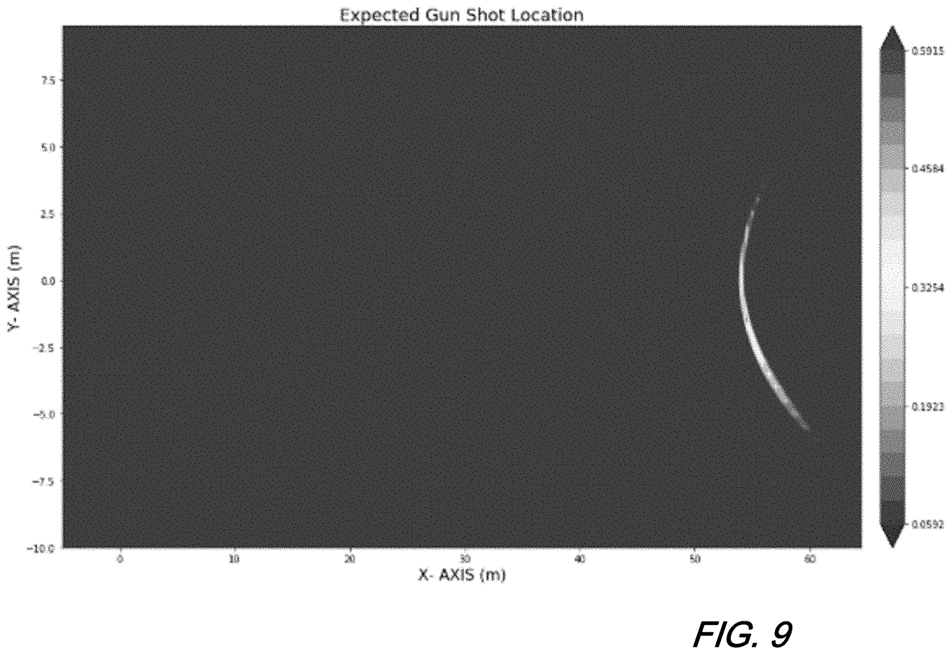

FIG. 8 is a plot showing a calculated most probable acoustic event (gunshot) location shown on a 2D map according to aspects of the present disclosure; and FIG. 9 is a plot showing a heat-map-like demonstration of possible acoustic event location (gunshot) shown on a 2D map according to aspects of the present disclosure.

Those skilled in the art will readily understand and appreciate that additional analysis capabilities can be added to our inventive system and method as well, such as classification of the acoustic event (whether it is a gunshot, an explosion, a car accident, etc—among others) by performing spectral analysis and machine learning models that may include neural network structures and methods as part of the interrogator/analysis systems and methods. Such detected/analyzed events may then be reported to appropriate responders and/or authorities to take an appropriate action or actions.

With this disclosure in place, we may now provide experimental results of our systems and methods as applied to real-world environment(s). The experiments are conducted in our research testbed consisting of three real-scale class II utility poles, with installed power cables and a single-mode telecom fiber cable. The poles are 35 feet long and placed 90 feet apart from each other in a linear arrangement. The aerial fiber cable used in the experiments is an outdoor figure-8 cable with 36 fiber cores supported by a 0.25-inch messenger wire. The fiber cable is installed on the poles at a height of ˜4 meters.

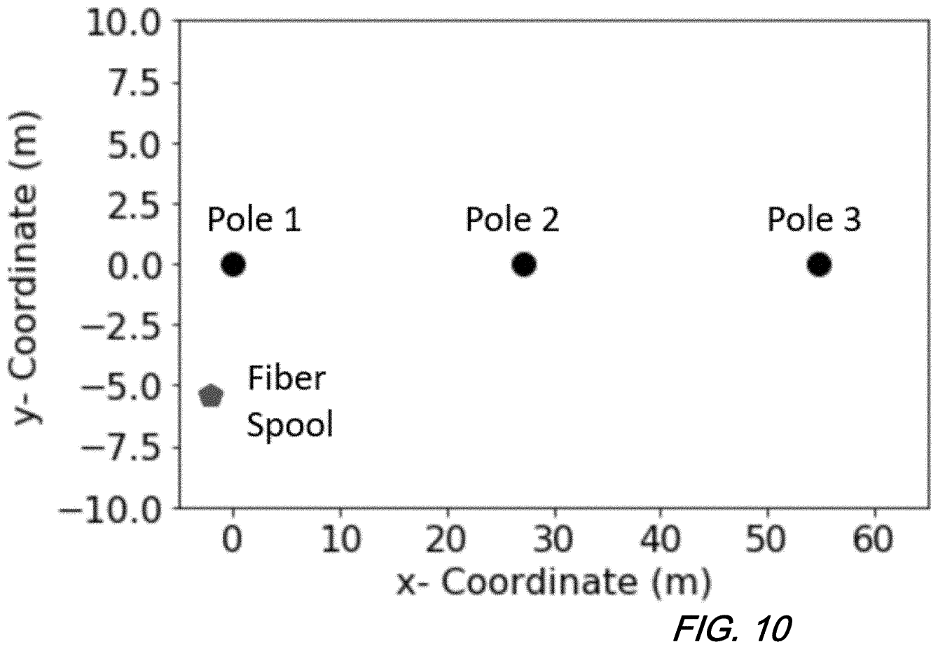

To localize the acoustic sound source by triangulation, a linear arrangement of the sensors is not preferred, therefore in addition to the 3 poles, we have placed a fiber spool on the ground near one end of the pole line to break the symmetry. These 4 locations (3 poles, and 1 fiber spool) are chosen as our “virtual microphones” to be used as reference points for acoustic source localization. The DAS system was located inside a control office approximately 350 meters away from the first pole (located in the origin of our testbed) in terms of fiber distance. A birds-eye view plan of the testbed is shown illustratively in FIG. 10.

The DAS system was operated at an optical pulse width of 40 ns, at a pulse repetition rate of 20 kHz. The spatial resolution of the system was—1.22 meters. The locations of the poles and the fiber spool along the fiber optic cable were obtained by analyzing the DAS data of manual hammer hits at each location.

The geographical locations of those points were measured using an industrial tape measure with an expected error of ±15 cm, relative to Pole 1, which was chosen as the origin of the testbed coordinate system. The locations of these reference points along the fiber cable and in the testbed coordinate system are given in the following table.

Locations of Reference Points, Relative to Fiber Optic Cable and
Relative to Coordinate System - All Distances Are In Meters

| Reference | Location Along Fiber Optic | Location At Testbed |
|---|---|---|
| Point | Cable | (x, y, z) |
| Spool 1 | 551 | (−2.1, −5.46, 0) |
| Pole 1 | 349 | (0, 0, 4) |
| Pole 2 | 380 | (27, 1, 0, 4) |
| Pole 3 | 412 | (54.7, 0, 4) |

A .32 caliber starter gun, shooting short black powder blanks was utilized as the impulsive acoustic source, and fired once at 4 different locations, above head level approximately 2 meters above the ground at the testbed. The DAS signatures of each shot are recorded separately and analyzed to calculate the location of the impulsive acoustic event.

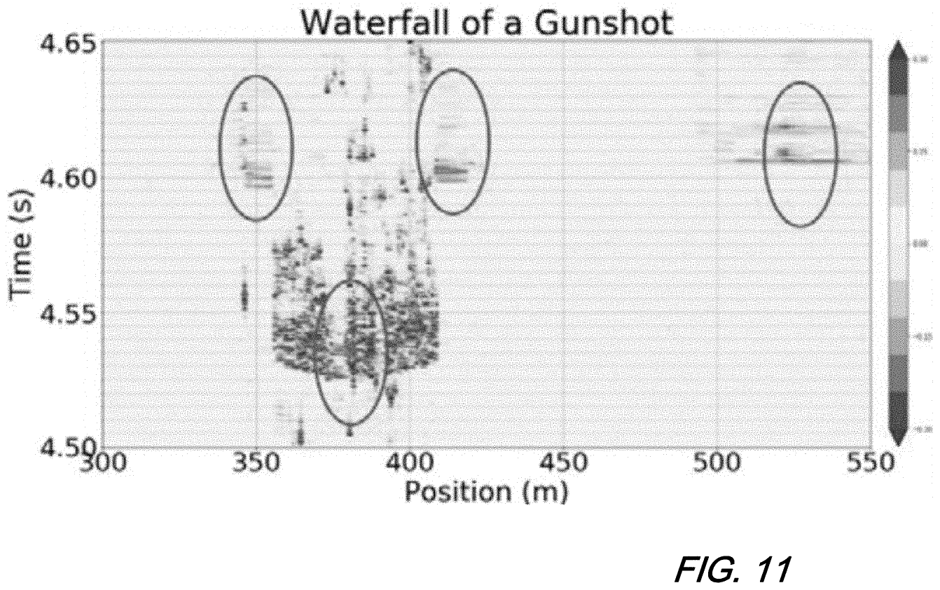

FIG. 11 is a plot showing an illustrative waterfall image of an acoustic event detected by DAS in which each ellipse corresponds to a different sensor point for our illustrative experimental testing according to aspects of the present disclosure;

The starter gunshot events are illustrated in a “waterfall” trace plot in the figure, which is a 2D representation of the detected DAS signal along the interrogated fiber length (x-axis), and how it changes in time (y-axis) where the signal strength may be color-coded. This figure shows a total time duration of 150 milliseconds at the fiber range between 300 m-550 m.

As one can observe in the waterfall plot, the same acoustic event is detected by different parts of the same aerial fiber optic cable (aerial is another term for cables suspended from utility poles) at slightly different times shown with red ellipses. By knowing the actual locations of these reference points and the time difference of arrival (TDOA) of the acoustic signal at multiple reference points, it is possible to determine/calculate the source location.

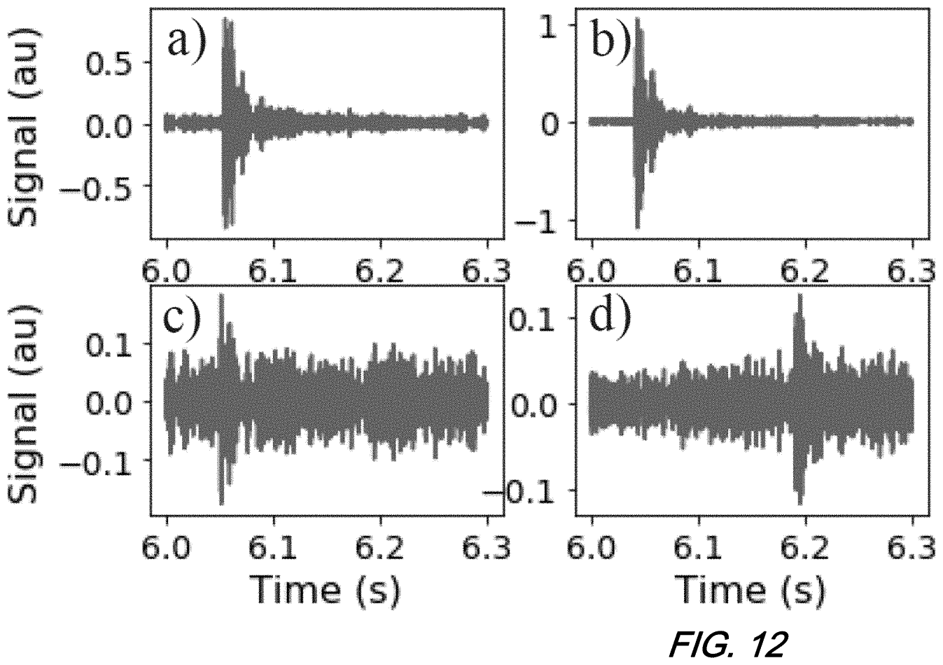

FIG. 12 is a plot showing detected acoustic event by four reference points a) spool, b) pole, c) pole 2 and d) pole 3 for our experimental testing according to aspects of the present disclosure.

To determine the time of arrival, we employ an online change-point detection algorithm based on Z-score. In this approach, we characterize the distribution of sensing measurements prior to the arrival of acoustic events by its running mean and variance, and for the next data point, we compute the probability of observing a value that is at least as extreme as the value observed, under the assumption that it is drawn from the same distribution.

The threshold (p-value) in our algorithm was chosen as 0.001, so the earliest data value with a probability below this threshold is registered as a change point, and its time coordinate is taken as the signal arrival time. Once the relative time differences are calculated we use the 3-D triangulation formula to obtain the source location as follows:

\sqrt{(xₛ−xᵢ)²+(yₛ−yᵢ)²+(zₛ−zᵢ)²}−\sqrt{(xₛ−xⱼ)²+(yₛ−yⱼ)²+(zₛ−zⱼ)²}=c˜Δτij

In this equation x, y, and z are the standard coordinates. The subscripts s, i and j are denoting the “source”, i-th sensor, and j-th sensor respectively and c is the speed of sound taken as 343 m/s, and Δτij is the relative time difference of arrival between i-th and j-th sensors.

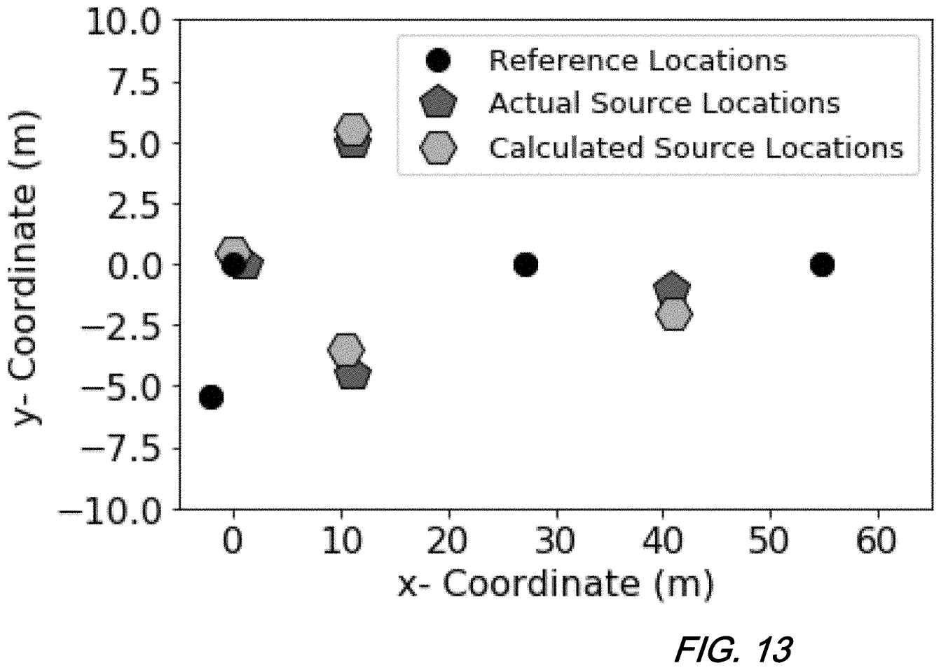

By using the above equation/relationship after the change-point detection algorithm, the coordinates of the source location are determined/calculated. The actual gunshot locations and their calculated locations at cross-section z=2 m are illustrated in FIG. 13, together with the reference point locations. FIG. 13 is a plot showing illustrative source locations together with actual source locations on test bed map for our experimental testing according to aspects of the present disclosure.

At this point we note that since DAS systems measure strains by measuring differential phase changes over a fiber segment of one gauge length, the reference microphones based on our DAS technology collect acoustic energies spatially accumulated along the fiber segments about 1.22 m long instead of in a truly point manner. Despite this linear spatial-reception footprint of the reference microphones, the deviations to the true source locations by our method were still less than 1.12 meters. It is to be noted that, part of this inaccuracy is due to the manual localization errors of reference points and actual event locations. In summary, we describe herein acoustic source localization using standard aerial

Telecommunication fiber optic cables—including those deployed and operating to actively carry telecommunications traffic. Our experimental results verify our approach of integrating DAS technology to existing aerial telecommunications fiber optic networks for smart city and safer city applications that advantageously reduce installation costs associated with such systems.

In addition, systems, methods, and structures according to aspects of the present disclosure may advantageously provide for the use of DAS for continuous monitoring of a large area for acoustic impulse events by employing fiber optic cables already deployed in an urban setting as a “microphone array”.

Advantageously, our inventive techniques employ DAS for detection and localization of acoustic impulse events by using time-frequency-spatial domain methods for data analysis including using spatial distribution of the fiber optic as part of sensing configuration and using frequency filtering optimization to preprocess the data, using time-domain change point-detection method for relative time of arrival estimation and formulation of the localization as an optimization problem (rather than equation solving) to estimate the event location (using multiple measurements), with a notion of uncertainty quantification and then informing relevant authorities on the detected event time and location(s).

At this point, while we have presented this disclosure using some specific examples, those skilled in the art will recognize that our teachings are not so limited. Accordingly, this disclosure should only be limited by the scope of the claims attached hereto.

1. A city-scale acoustic impulse detection and localization method comprising:
providing a distributed fiber optic sensing system (DFOS), said system including a length of optical fiber; and
a DFOS interrogator and analyzer in optical communication with the length of optical fiber;
said method comprising:
operating the DFOS during the acoustic impulse event;
determining, by the DFOS, that that acoustic impulse event occurred by detecting signals produced by mechanical vibrations induced in the optical fiber from the acoustic impulse event;
performing a spatial and temporal analysis on the detected signals;
generating a probability distribution of source location of the acoustic impulse event; and
outputting one or more indicia of the generated probability distribution.

2. The method of claim 1 further comprising:
determining a set of virtual microphones for the spatial analysis, each one of the virtual microphones located at a different physical position along the length of the fiber.

3. The method of claim 2 further comprising:
determining, during temporal analysis, a time of arrival of signals associated with each of the individual virtual microphones.

4. The method of claim 3 wherein each individual one of the virtual microphone locations is one selected from the group consisting of: a down-lead fiber along a pole, a spool of fiber, a fiber connection point to a pole or other fixed structure, and a central part of a length of the fiber.

5. The method of claim 4 further comprising, analyzing a signal produced at each of the virtual microphone locations using a change point detection method and generating the time of arrival of the signal for each microphone.

6. The method of claim 5 further comprising selecting a change point for each virtual microphone.

7. The method of claim 6 further comprising generating a time difference matrix including a time difference between all virtual microphone combinations.

8. The method of claim 7 further comprising generating a most probable location of the acoustic impulse event from the time difference matrix and geometric physical locations of the virtual microphones.

9. The method of claim 8 wherein the most probable location is determined by a 3-dimensional acoustic-location-error function whose minimum value provides the most probable location of the acoustic impulse event.

10. The method of claim 9 wherein the source location is determined according to the following relationship:
\sqrt{(xₛ−xᵢ)²+(yₛ−yᵢ)²+(zₛ−zᵢ)²}−\sqrt{(xₛ−xⱼ)²+(yₛ−yⱼ)²+(zₛ−zⱼ)²}=c˜Δτij
where x, y, and z are standard coordinates, subscripts s, i, and j denote the “source”, i-th sensor, and j-th sensor respectively and c is the speed of sound taken as 343 m/s, and Δτij is the relative time difference of arrival between i-th and j-th sensors.
